(19) United States
(12) Patent Application Publication
(10) Pub. No.: US 2008/0190402 A1
(43) Pub. Date: Aug. 14, 2008

(54) Motor Vehicle Heating System

(76) Inventors: Vitali Schmidt, Munchen (DE); Michael Keppler, Unterhaching (DE)

Correspondence Address: DICKINSON WRIGHT PLLC, 1901 L. STREET NW, SUITE 800, WASHINGTON, DC, 20036, US

(21) Appl. No.: 11/909,801

(22) PCT Filed: Mar. 31, 2006
(86) PCT No.: PCT/DE2006/000580

§ 371 Date: Sep. 27, 2007

(30) Foreign Application Priority Data
Apr. 1, 2005 (DE) 10 2005 015 116.7

(51) Int. Cl. F02M 31/125

(52) U.S. Cl. 123/549; 123/495

(57) ABSTRACT

The invention relates to an automotive heater (10) which is designed

for operation with liquid fuel and which has a fuel pump (16′, 16) and a damping element (34, 66) comprising an elastomer (36, 68) for damping pulsations generated by the fuel pump (16′, 16).

According to this invention, means (58, 78a, 78b, 78c, 80, 82) are provided for heating the elastomer (68). It is especially preferable for the automotive heater to have an electromagnetically operated fuel valve (52) and for the damping element (66) to be provided in the area of the electromagnetically operated fuel valve (52) and in particular to be integrated into it.

The present invention relates to an automotive heater, which is designed to be operated with liquid fuel and has a fuel pump and a damping element comprising an elastomer for damping pulsations generated by the fuel pump.

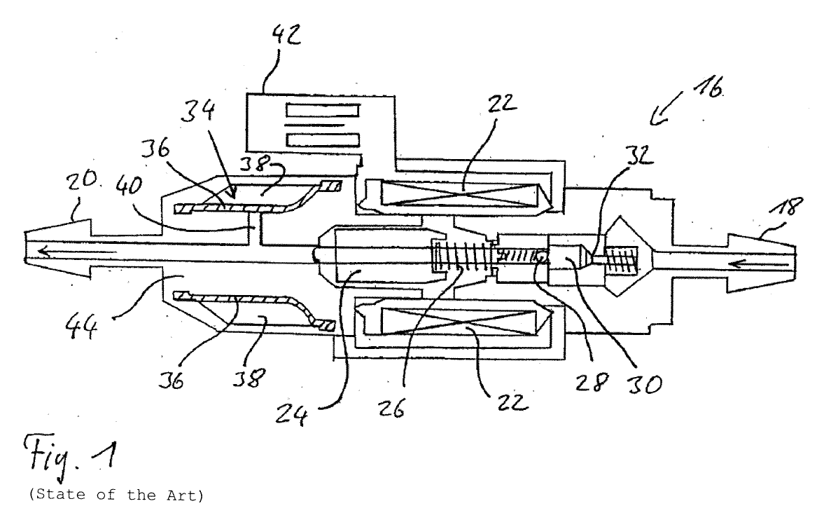

A reciprocating piston fuel pump that generates pulsations in the fuel system during operation is known, for example, from the publication Fahrzeug- und Verkehrstechnik, Technische Mitteilungen, vol. 97 (2004) no. 1, pages 9 through 11, and is shown as a schematic sectional view in FIG. 1.

The reciprocating piston fuel pump 16′ illustrated in FIG. 1 is provided for conveying liquid fuel in the direction illustrated by the arrows, namely from a fuel inlet 18 to a fuel outlet 20. As soon as a suitable voltage is applied to an electric terminal 42, electricity flows through a winding 22, initiating movement electromagnetically by a reciprocating piston 24. First, liquid fuel in a pump chamber 30 is ejected via a nonreturn valve 28 against the hydraulic resistance of the output line. Thereafter, the electric power running through the winding 22 is terminated. A restoring spring 26 presses the reciprocating piston 24 toward the left into its resting position. Liquid fuel is drawn in through a feeder intake valve 32, filling the pump chamber 30. Very low viscosity fuels can also be pumped volumetrically with precision by this delivery principle. The delivery volume can be controlled very accurately via the frequency of the triggering voltage pulses.

However, unwanted pulsations occur in the fuel system due to the back-and-forth movement of the reciprocating piston 24. To at least partially suppress these pulsations, it is already known that a damping element 34 comprising a bellows-like elastomer 36 may be provided. When liquid fuel passes through a borehole 40 and comes in contact with the elastomer 36, the elastomer 36 expands into a neighboring chamber 38, which is provided in a damper housing formed by a molded plastic part 44. The prerequisite for this is a certain backpressure in the fuel system, which ensures that the elastomer 36 will be “secured.”

One problem with the reciprocating piston fuel pump 16 illustrated in FIG. 1 is that the damping element 34 has little or no function at all in extreme ambient cold, e.g., at temperatures below !23° C., because the elastomer 36 hardens, i.e., undergoes a glass transition (a typical elastomer point [sic; glass transition point] of elastomer 36 is !23° C., for example). Another problem is that the so-called Arctic¹ diesel, which is the only fuel approved for use for diesel burners at temperatures below !20° C., produces a much lower back pressure at temperatures below !20° C. because of the lower viscosity than winter diesel at room temperature. The functionality of the damping system 34 is therefore reduced even before reaching the elastomer point² of the elastomer 36. At “moderately” cold temperatures higher than !20° C., for example, this leads under some circumstances to an increase in CO emissions by the automotive heater caused by pulsations in the fuel system. At extremely low temperatures below !30° C., for example, the problem may even occur that stabilization of fuel operation is prevented by the pulsations in the fuel system. Although the burner may start in such cases, when the glow plug goes out, i.e., without supporting energy for the root of the flame, however, the burner becomes destabilized as time progresses until it finally goes out. Such an unwanted extinction may occur, for example, within 0 to 5 minutes after turning off the glow plug. ¹TN: The present text consistently uses “Artikdiesel” apparently in reference to “Arctic diesel”; instead of using a “sic” each time, I do each instance here as “Arctic diesel.”²TN: The term “elastomer point” has not turned up in a search online, in plastics textbooks or dictionaries—from the text this appears to refer to “glass transition temperature” (Glasübergang, Glasübergangstemperatur).

The object of the present invention is to improve upon the generic automotive heaters in such a way that the problems described above are avoided and pulsation-free pumping of fuel is possible even at temperatures of less than !20° C., for example.

This object is achieved through the features of the independent claims.

Advantageous embodiments and refinements of the invention are derived from the dependent claims.

The inventive automotive heater is designed according to the generic state of the art by the fact that means are provided for heating the elastomer. Heating of the elastomer by )x° C. until reaching the full-load point corresponds to a direct expansion/lowering of the effective operating range of the damping element and thus in particular the characteristics map of the burner of an automotive heater by the same )x° C. into the negative temperature range. For example, operation of an automotive heater with Arctic diesel at !30° C. is possible through the approach according to the present invention. Lower pulsation intensities in the fuel system occur due to the heated elastomer, which is therefore softer, and therefore the burner of an automotive heater can be operated at moderately lower temperatures of more than !20° C., for example, so that it is more stable and has a more uniform and quieter combustion noise (pulsations generate a “rough” combustion noise). For example, in conjunction with automotive heaters, the tendency to flame blow-off when the temperature drops below a certain limit temperature of !25° C., for example, is shifted toward lower temperatures due to the smaller pulsations. At “higher” temperatures of 0° C. to !20° C., for example, a reduction in CO emissions can be achieved with automotive heaters for use with Arctic diesel as well as winter diesel due to the smaller pulsations.

According to a preferred further embodiment of the inventive automotive heater, it has an electromagnetically operated fuel valve and the damping element is located in the area of the electromagnetically operated fuel valve. Such an electromagnetically operated fuel valve is frequently provided between the fuel pump and a burner/heat exchanger unit, in particular to shut down the fuel supply. Although the damping element may in principle be arranged at any location, an arrangement near the electromagnetically operated fuel valve is preferred, because then the power supply voltage to the fuel valve may be used for heating the elastomer in parallel.

In this context, it is considered especially advantageous if the damping valve is integrated into the electromagnetically operated fuel valve. Integration of the damping element into the fuel valve reduces the number of required components and is therefore especially inexpensive.

According to another preferred embodiment of the inventive automotive heater, the means for heating the elastomer are integrated into the electromagnetically operated fuel valve. In this case, the electric triggering for heating the elastomer can be combined in an especially simple manner with the triggering of the fuel valve.

In certain embodiments of the inventive automotive heater, the means for heating the elastomer include an electric heater. The electric heater may be provided directly or indirectly. For example, a heating wire such as that known for heating windshields as well as ski equipment and other equipment may be integrated into the elastomer material. The heating wire is preferably supplied with electric power before the start of the actual fuel delivery in such a way that the limit temperature for the required minimum elasticity is exceeded at the start of the fuel delivery. The electric heater may, however, also comprise heating elements, e.g., PTC heating elements, which are provided for heating liquid fuel within the fuel valve. One or more such heating elements may be connected in parallel to the winding of the electromagnet, for example. Separate triggering is of course also possible. For example, PTC heating elements have a very large resistance temperature coefficient. Therefore, in a cold start, the small quantity of fuel in the fuel valve is rapidly heated to a maximum temperature of 50° C., for example. At such a temperature level, the resistance of the heating conductor is so great that no mentionable heating power is being delivered anymore. The heated fuel then heats the elastomer and consequently increases its elasticity. Additionally or alternatively, it is also possible for corresponding heating elements to be provided near the elastomer to heat the latter.

Furthermore, according to the present invention, it is possible for the means for heating the elastomer to include a winding of the electromagnetically operated fuel valve.

The power consumed by the windings and/or magnetic coils of known fuel valves is converted primarily to heat and is sufficient in many cases to heat the elastomer, in particular at low temperatures.

In this context, it is also preferable for a material having a high thermal conductivity to be provided in an area between a winding of the electromagnetically operated fuel valve and the elastomer. Metals in particular, e.g., aluminum, may be used as the material having a high thermal conductivity. It is possible here for metal ribs or metal housing components in contact with the damping element to form one or more heat bridges.

According to another embodiment of the invention which is also preferred, a material having a low thermal conductivity is provided in the area between the elastomer and the environment. In principle, any thermal insulation material with which those skilled in the art are familiar, e.g., foamed plastics and/or expanded metals, may be used as the material having a low thermal conductivity. Due to such thermal insulation with respect to the environment, exhaust heat from the fuel valve can be utilized advantageously for heating the elastomer.

At least in some embodiments of the inventive automotive heater, it is possible to provide for the electromagnetically operated fuel valve to be designed to preheat the fuel. Fuel heating leads to an increase in the enthalpy of the fuel and to a reduction in viscosity, which has a positive effect on combustion operation. In addition, the preheated fuel may be used to heat the elastomer.

Preferred embodiments of the invention are explained in greater detail below on the basis of the drawings as an example.

FIG. 1 shows a schematic sectional view through a known reciprocating piston fuel pump, which was explained already in the introduction;

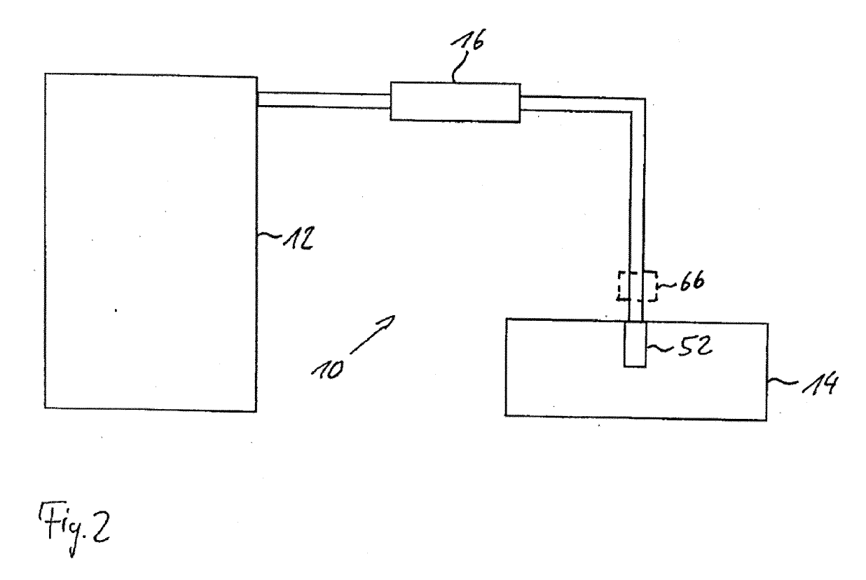

FIG. 2 shows a schematic block diagram of an embodiment of the inventive automotive heater;

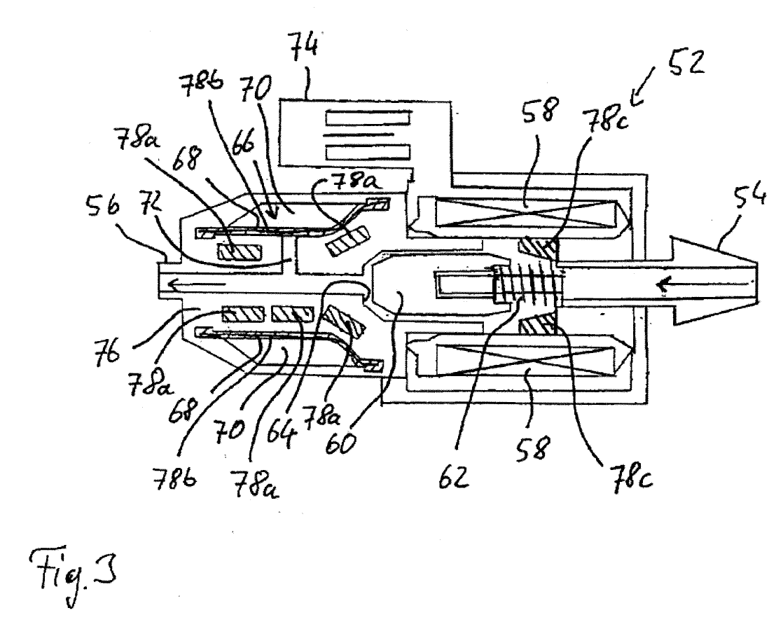

FIG. 3 shows a schematic sectional view of a first embodiment of a fuel valve which may be part of the inventive automotive heater from FIG. 2;

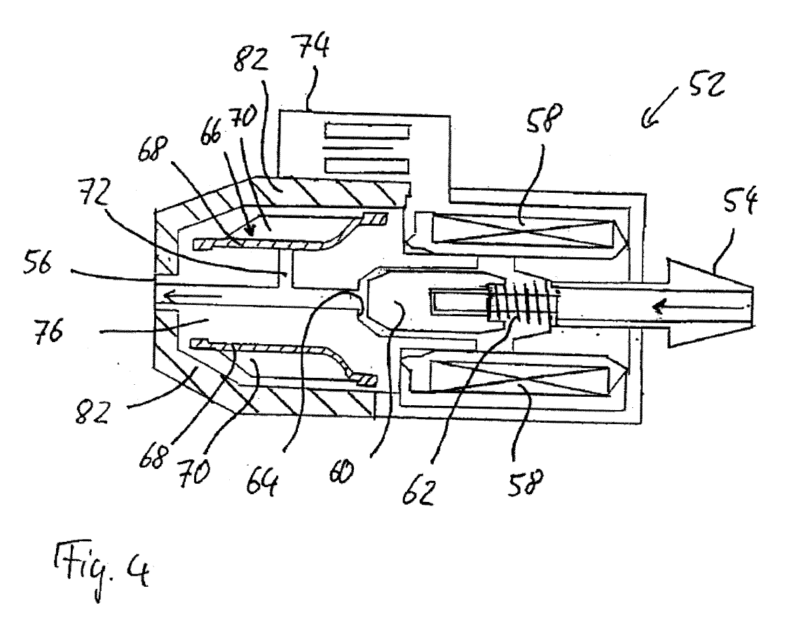

FIG. 4 shows a schematic sectional view of a second embodiment of a fuel valve, which may be part of the inventive automotive heater from FIG. 2; and

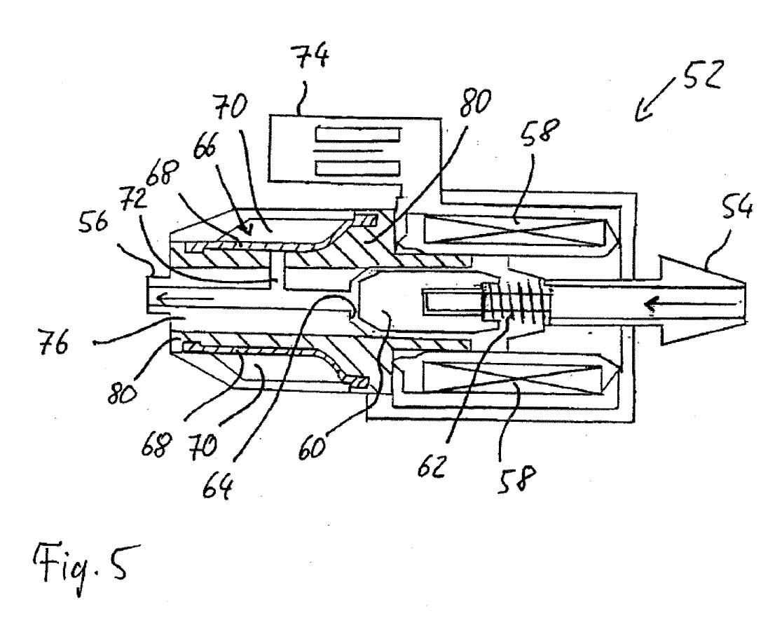

FIG. 5 shows a schematic sectional view of a third embodiment of a fuel valve, which may be part of the inventive automotive heater from FIG. 2.

FIG. 2 shows a schematic block diagram illustrating one embodiment of the inventive automotive heater. The automotive heater 10 shown here may be an additional heater or an auxiliary heater, for example. The automotive heater 10 shown here comprises a reciprocating piston fuel pump 16 with the help of which liquid fuel can be conveyed from a fuel tank 12 to a burner/heat exchanger unit 14. Depending on whether air or water heating is used, the burner/heat exchanger unit is connected to other air and/or water lines (not shown here), with which those skilled in the art are very familiar. The burner/heat exchanger unit 14 also comprises a fuel valve 52 with which the fuel supply can be shut down partially or entirely. This fuel valve 52 need not necessarily be integrated into the fuel/heat exchanger unit 14 but instead may also arranged between the reciprocating piston fuel pump 16 and the burner/heat exchanger unit 14.

The damping element 66 and the means assigned to it for heating the elastomer are preferably integrated into the electromagnetically operated fuel valve 52. However, it is also possible for damping element 66 and/or means assigned to it for heating the elastomer to be designed separately from the electromagnetically operated fuel valve 52, as indicated with dotted lines. The damping element may be arranged at any location in a fuel line and may be designed like the embodiments described below.

FIG. 3 shows a schematic sectional view of a first embodiment of a fuel valve 52, which may be part of the automotive heater 10 of FIG. 2. The fuel valve 52 may be an electromagnetically operated coaxial valve which has a fuel inlet 54 and a fuel outlet 56. As soon as a suitable voltage is applied to an electric terminal 74, electricity passes through a winding 58, inducing a movement of the valve piston 60 to the right, based on a diagram in FIG. 4, so that the fuel valve 52 opens and fuel can flow from the fuel inlet 54 to the fuel outlet 56. In the currentless state of the winding 58, a restoring spring 62 forces the valve piston 60 to the left, based on the diagram in FIG. 3, so that the valve piston 60 cooperates with a valve seat 64 to close the fuel valve 52.

According to the diagram in FIG. 3 the damping element 66 which is provided for suppressing pulsations in the fuel system, is integrated into the fuel valve 52. The damping element 66 comprises a bellows-like elastomer 68. When liquid fuel passes through a borehole 72 and comes in contact with the elastomer 68, the elastomer 68 expands into a neighboring chamber 70, which is provided in a damper housing formed by a molded plastic part 76. The prerequisite for this is a certain backpressure in the fuel system which ensures that the elastomer 68 is “secured.”

To prevent the glass transition from taking place in the elastomer 68 formed from the material FKN, for example, even at very low temperatures of less than !23° C., for example, an electric heater 78 is allocated to the damping element 66. In the example presented here, the electric heater 78 includes multiple PTC heating elements 78a which are situated in the vicinity of the elastomer 68, at least one heating wire 78b, which is integrated into the elastomer 68, and two PTC heating elements 78c, which are provided for heating the fuel. It is clear that not all the heating elements 78a, 78b and 78c depicted here need be present, but instead optionally it may be sufficient to provide only one type of heating element 78a, 78b or 78c to heat the elastomer 68b to a suitable extent. To optimize the effect of the PTC heating elements 78a, it is advantageous if a material having a higher thermal conductivity, e.g., a metal is provided between the area to be heated, i.e., the elastomer 36, and the respective PTC heating element. The most direct heating of the elastomer 68 is achieved by the heating wires 78b. The PTC heating elements 78a heat material that comes in contact with the elastomer 68 as well as material coming in contact with liquid fuel. The PTC heating elements 78a serve primarily to heat the fuel. Preheating of the fuel is used for indirect heating of the elastomer 68 and leads to better combustion. Some or all of the heating elements 78a and 78b described here may be connected to the winding 58 in parallel or they may be triggered separately. Separate triggering is more complex but it allows preheating independently of the valve setting.

The fuel valve 52 shown in FIG. 4 differs from the embodiment according to FIG. 3 in that no heating elements are provided there but instead the elastomer 68 is heated by the exhaust heat from the fuel valve 52. To make this heating possible and/or optimize it, the area of the damping element 66 is surrounded by a material 82 of a low thermal conductivity, i.e., any thermal insulation material with which those skilled in the art are familiar such as expanded metal and/or plastic foam. Although this is not shown here, the material 82 having a low thermal conductivity may optionally have a layered structure. It is clear that when the fuel valve 52 is opened, enough exhaust heat is generated due to the corresponding electric flow to the winding 58 to heat the elastomer 68. However, the fuel valve 52 may also be designed so that a lower electric current to the winding 58 which does not result in opening of the fuel valve 52d is still sufficient to heat the elastomer 68.

The embodiment of the fuel valve 52 shown in FIG. 5 differs from the embodiment according to FIG. 3 in that no heating elements are provided there but instead the heating of the elastomer 68 is accomplished by the heat generated in the winding 58 and carried over at least one heat bridge to the elastomer 68. To this end, a material 80 having a high thermal conductivity is provided between the winding 58 and the elastomer 68. The material 80 having a high thermal conductivity may be in particular a metal, in which case the shaping may be in the form of ribs, for example, to create a suitable heat bridge. Although this is not shown here, it may also be advantageous to carry the heat bridge also to areas which come in contact with the liquid fuel in order to heat the fuel. In the case presented here, the material 80 with a high thermal conductivity is integrated into the molded plastic part 76 in the form of metal ribs, however, and heats only the elastomer 68 at least predominately.

It is clear to those skilled in the art that the embodiments of the fuel valve 52 explained on the basis of FIGS. 3 through 5 may be combined with one another and also that all these possible combinations are herewith disclosed.

The present invention makes it possible to ensure burner operation even at very low temperatures of less than !20° C., for example. If necessary, a favorable elastomer may be selected because its glass transition can be reliably prevented through the heating.

The features of the invention disclosed in the present description as well as in the drawings and claims may be essential to the implementation of the invention either individually or in any combination.

### LIST OF REFERENCE NUMERALS

10 automotive heating
12 fuel tank
14 burner/heat exchanger unit
16 reciprocating piston fuel pump
18 fuel inlet
20 fuel outlet
22 winding
24 reciprocating piston
26 restoring spring
28 nonreturn valve
30 pump chamber
32 feeder intake valve
34 damping element
36 elastomer
38 chamber
40 borehole
42 electric connection
44 molded plastic part
52 fuel valve
54 fuel inlet
56 fuel outlet
58 winding
60 valve piston
62 restoring spring
64 valve seat
66 damping element
68 elastomer
70 chamber
72 borehole
74 electric terminal
76 molded plastic part
78 heating element
80 material with a high thermal conductivity/metal rib
82 material with a low thermal conductivity/insulator

1. Automotive heater (10) designed to be operated with liquid fuel, having a fuel pump (16′, 16) and a damping element (34, 66) surrounding an elastomer (36, 68) for damping pulsations generated by the fuel pump (16′, 16), characterized in that means (58, 78a, 78b, 78c, 80, 82) for heating the elastomer (68) are provided.

2. Automotive heater according to claim 1, characterized in that it has an electromagnetically operated fuel valve (52) and the damping element (66) is provided in the area of the electromagnetically operated fuel valve (52).

3. Automotive heater according to claim 1 or 2, characterized in that the damping element (66) is integrated into the electromagnetically operated fuel valve (52).

4. Automotive heater according to any one of the preceding claims, characterized in that the means (58, 78a, 78b, 78c, 80, 82) for heating the elastomer (68) are integrated into the electromagnetically operated fuel valve (52).

5. Automotive heater according to any one of the preceding claims, characterized in that the means (58a, 78a, 78b, 78c, 80, 82) for heating the elastomer (68) comprise an electric heater (78a, 78b, 78c).

6. Automotive heater according to any one of the preceding claims, characterized in that the means (58, 78a, 78b, 78c, 80, 82) for heating the elastomer (68) comprise a winding (58) of the electromagnetically operated fuel valve (52).

7. Automotive heater according to claim 6, characterized in that a material (80) with a high thermal conductivity is provided in an area between a winding (58) of the electromagnetically operated fuel valve (52) and the elastomer (68).

8. Automotive heater according to claim 6 or 7, characterized in that a material (82) having a low thermal conductivity is provided in an area between the elastomer (68) and the environment.

9. Automotive heater according to any one of claims 2 through 10, characterized in that the electromagnetically operated fuel valve (52) is designed for preheating fuel.
